(19) United States
(12) Patent Application Publication
(10) Pub. No.: US 2017/0118636 A1
(43) Pub. Date: Apr. 27, 2017

(54) WIRELESS NODES WITH SECURITY KEY

(71) Applicant: Photonstar LED Limited, Hampshire (GB)

(72) Inventor: Majd Zoorob, Southampton (GB)

(73) Assignee: Photonstar LED Limited, Hampshire (GB)

(21) Appl. No.: 15/305,975

(22) PCT Filed: Mar. 24, 2015
(86) PCT No.: PCT/GB2015/050867

§ 371 Date: Oct. 21, 2016

(30) Foreign Application Priority Data
Apr. 2, 2014 (GB) 1405951.3

(51) Int. Cl. H04W 12/04; H04L 9/08

(52) U.S. Cl. CPC H04W 12/04; H04L 9/0866; H04L 2463/062; H04L 63/18

(57) ABSTRACT

A method of commissioning wireless node devices in a private wireless network without compromising the security of the network, and also wireless devices adapted to commission and to be commissioned in such a manner. A commission key is provided out-of-band for use in commissioning the wireless node device and an identification key is provided for uniquely identifying the wireless node device on the private wireless network. An encrypted network key for the private wireless network is also provided over the wireless medium and is decrypted using an encryption key generated from the commission key and the identification key. The decrypted network key is used to associate the wireless node device with the private wireless network. The method and devices find particular application in wireless lighting systems, and the control thereof.

### FIELD OF THE INVENTION

The present invention relates to wireless personal area networks (WPAN) and the corresponding association of nodes and coordinators to such networks.

### BACKGROUND OF THE INVENTION

Wireless network systems with wireless devices communicating wirelessly are becoming increasingly common for many different applications. To operate a network system it is usual for each device in the network to be an addressable node for communication with the device. This requires that the network be appropriately configured to recognise devices in the network and to take account of any changes that occur in the configuration of the network, such as a node joining or leaving the network.

The process of configuring such a wireless network and associated nodes is generally termed commissioning. This can be quite a manual process unless a more user-friendly form of component installation is provided.

Wireless networks can take a number of forms, including the so-called wireless personal area network (WPAN). Similarly, the nodes in a wireless network may be embodied in various addressable devices, including control units and controllable devices, such as wireless lighting nodes, lighting and building control nodes, environmental sensor nodes and actuator nodes.

Wireless lighting nodes may form part of a larger lighting and building control and management system and may comprise of retro-fit or replacement lamps or lighting fixtures, or else dedicated lighting products such as downlighters, tracklights, spotlights and recessed and suspended office lighting.

In order to associate new nodes to a WPAN network a designated master node is employed to coordinate the joining of such new nodes, and this designated master node may be termed coordinator. The WPAN network may have more than one coordinator and the coordinator may have other roles and responsibilities in the WPAN network. For the purpose of illustration it will be assumed that one coordinator will exist in the WPAN network.

Several methods have been proposed to provide manual configuration of wireless devices. One of the most common methods employed in IEEE 802.11 wireless networks and introduced by the Wireless Ethernet Compatibility Alliance employs an identifier for the network. The identifier in this case is otherwise known as a Service Set Identification (SSID). When a wireless node tries to associate itself to a selected SSID a security key is requested. The security key is pre-configured and stored on the coordinator. The coordinator will not allow the wireless node to associate to the network unless the correct security key is entered. This requires physical, out of the wireless band, entry of the security key by the user on the wireless node.

This process is secure, but requires the wireless node to have a means of key entry such as a keyboard. In the context of a wireless lighting network this may not be feasible, as the user may not have access to the wireless lighting node, for example if it is attached to a ceiling fixture. Additionally, the wireless lighting node may not have a means for data entry.

US20110149803 describes a wireless node association process which employs a trusted secondary wireless channel to allow pre-defined code data to be shared between the wireless node and the coordinator. Once the code data is shared, then the wireless node is associated.

However, this method introduces vulnerabilities as the trusted channel is not secured during the association. In such a situation, wireless nodes could accidentally or intentionally be associated to a non-authorised neighbouring or overlapping network prior to them being associated and commissioned to the actual desired WPAN network, thereby rendering the wireless nodes vulnerable to security or safety threats.

Therefore, there is currently a need for an improved method of commissioning certain types of wireless nodes in a wireless network without compromising the security of the network, and for devices adapted to commission and be commissioned in such a way.

### SUMMARY OF THE INVENTION

According to a first aspect of the present invention there is provided a wireless node device adapted to associate with a private wireless network over a wireless medium, the wireless node device comprising:
memory storing a commission key and an identification key, the commission key for use in commissioning the wireless node device and the identification key comprising a unique identifier for uniquely identifying the wireless node device on the private wireless network;
means for notifying the commission key out-of-band;
means for notifying the identification key;
means for receiving an encrypted network key for the private wireless network over the wireless medium;
a processor adapted to execute:
   (i) a predefined encryption algorithm to generate an encryption key by a mathematical combination of the commission key and the identification key; and,
   (ii) a predefined decryption algorithm to decrypt the received encrypted network key using the generated encryption key; and,
a physical data transport layer adapted to utilise the decrypted network key to associate the wireless node device with the private wireless network.

According to a second aspect of the present invention there is provided a wireless coordinator device adapted to coordinate association of a wireless node device to a private wireless network over a wireless medium, the wireless coordinator device comprising:
memory storing a network key;
a physical data transport layer adapted to utilise the network key to associate the wireless coordinator device with the private wireless network;
means for receiving a commission key out-of-band, the commission key for use in commissioning the wireless node device;
means for receiving an identification key for the wireless node device, the identification key comprising a unique identifier for uniquely identifying the wireless node device on the private wireless network;
a processor adapted to execute:
   (i) a predefined encryption algorithm to generate an encryption key by a mathematical combination of the received commission key and the received identification key; and,
   (ii) a predefined encryption algorithm to encrypt the network key using the generated encryption key;
means for transmitting the encrypted network key to the wireless node device over the wireless medium.

According to a third aspect of the present invention there is provided a private wireless network comprising at least one wireless node device according to the first aspect of the invention associated with said private wireless network and at least one wireless coordinator device according to the second aspect of the invention associated with said private wireless network.

Thus, in the present invention a wireless coordinator device and node device is adapted to allow secure association and operation as part of a private wireless network, such as a Wireless Personal Area Network (WPAN).

According to a fourth aspect of the present invention there is provided a method of commissioning a wireless node device on a private wireless network, the method comprising the steps of, at the wireless node device:
notifying a commission key out-of-band, the commission key for use in commissioning the wireless node device;
notifying an identification key for the wireless node device, the identification key comprising a unique identifier for uniquely identifying the wireless node device on the private wireless network;
receiving an encrypted network key for the private wireless network over a wireless medium;
generating an encryption key by a mathematical combination of the commission key and the identification key; and,
decrypting the received encrypted network key using the generated encryption key; and,
utilising the decrypted network key to associate the wireless node device with the private wireless network.

Preferably, the method further comprises the steps of, at a wireless coordinator device:
receiving the commission key out-of-band;
receiving the identification key for the wireless node device;
generating an encryption key by a mathematical combination of the received commission key and the received identification key;
encrypting a network key for the private wireless network using the generated encryption key; and,
transmitting the encrypted network key over the wireless medium.

Thus, in a further aspect of the present invention a method of allowing a wireless node to securely associate and operate as part of a private WPAN is proposed. Of course, the method steps performed at the wireless coordinator device can be performed without reference to the step performed at the wireless node device.

The private WPAN of the present invention relies on sharing a secure network key with all associated wireless nodes and coordinators to ensure all these nodes operate as part of the same secure private network. This is held in the memory of each wireless node and only shared once securely during association of each node.

For the avoidance of doubt the term shared details the process whereby a key or data packet is transmitted between two or more devices wirelessly over the same communication channel as all other information. The term out-of-band or off-the-air communication further details the process whereby two or more devices communicate over either a different wireless channel or a wholly alternative means of wired or non-wired communication.

A wireless private network will have at least one coordinator that will manage the association, addition, removal and re-join of new wireless nodes. The coordinate may communicate insecurely with other devices outside the private network but on the same wireless channel. This enables new wireless nodes to associate with the private network. Once wireless nodes have successfully joined a WPAN network they will only communicate securely with other nodes and coordinators on the same network.

Association is termed as the point where the wireless node is in the process of being commissioned and prior to the wireless node receiving a WPAN secure network key for the first time. When the wireless node holds the network key in its memory then the wireless node can freely re-join the private WPAN network without the need to re-associate.

It is an object of the present invention for the association process to have minimum and simple human user steps. This is in order to minimise errors and accelerate the association process.

It is a further object of the present invention that the association process is implemented to ensure no accidental or intentional association to unauthorised neighbouring or overlapping networks is achieved prior to the wireless nodes joining the desired WPAN network.

It is a further object of the present invention that the network key may not be transmitted unsecurely outside the WPAN network. During the first association, a wireless node will receive the network key encrypted using the encryption key. The encrypted network key will be transmitted to the wireless node by the coordinator.

The encryption key is private to the wireless node attempting to associate but is also re-constructed by the coordinator during the first association. The formation and re-construction of the encryption key will be discussed in further detail below.

Having associated with a private WPAN, a wireless node will hold the secure network key. The network key is utilised by the wireless node to encrypt and decrypt all network data traffic that is part of the private network. Following this point the encryption key is no longer used by the wireless node.

The encryption key is constructed from a commission key and an identification key. A wireless node shall have memory to store a physical secure commission key and an unsecure unique identification key.

The identification key is unique to the wireless node and no other device may have the same identification key. The key can be, but not limited to, a username or Media Access Control (MAC) address. This identification key may be freely broadcast over the wireless network (over-the-air) by the device with no encryption and allows the device to be uniquely discovered and identified. Alternatively, the identification key may be shared, or notified, out-of-band (or off-the-air in the manner of the commission key.

Thus, while the identification key may be transported to the coordinator over an unsecure wireless band, the secure commission key is physically stored in the memory of the wireless node and is never shared across the wireless network (over-the-air).

The identification key may further comprise data packet information that details the device type or functionality of the wireless node. This is beneficial in the identification and set-up of the functionality of the device prior to the device joining the WPAN network.

The wireless node provides a means to share, or notify, the secure commission key of the wireless network out-of-band (or off-the-air) to ensure that the device can successfully associated and not compromise the security of the network key. This can be, but is not limited to, the simplified form of physical printing of the commission key on the wireless device. Other form out-of-band notification will be described below. The commission key is required in order for the coordinator to remotely re-construct the encryption key.

The wireless node contains a processor having an encryption algorithm. The algorithm for the generation of the encryption key is pre-defined by a mathematical combination or hash function of the commission key and the identification key. The mathematical combination may be randomly selected during key generation from a group of possible combinations.

Similarly the coordinator contains a processor having an encryption algorithm. The algorithm for the generation of the encryption key is re-constructed by a mathematical combination of the off-the-air commission key and the on-the-air identification key. The mathematical combination or hash function may also be randomly selected from a group of possible combinations.

The coordinator will transmit the network key encrypted using the encryption key at least partially over the unsecured wireless network to the wireless node. The wireless node will decrypt the network key using the matched algorithm and encryption key. This will enable the wireless node to associate with the private network.

If the randomly selected encryption keys do not match then the random combination is re-constructed at the coordinator and re-tried. If all the possible combinations are tried and the wireless node association was not successful then the user is notified that the commission key is incorrect or an unauthorised device attempted to join the private WPAN.

In some embodiments of the invention the associating wireless node may employ at least one additional wireless node that is part of the PAN network as a range extender in order to enable communication with a distant coordinator.

As will be appreciated by those skilled in the art, the present invention provides an improved and versatile method of commissioning wireless node devices in a wireless network without compromising the security of the network, and also wireless devices adapted to commission and be commissioned in such a manner. Further variations and embellishments will become apparent to the skilled person in light of this disclosure.

### BRIEF DESCRIPTION OF THE DRAWINGS

Examples of the present invention will now be described in detail with reference to the accompanying drawings, in which:

FIG. 1 shows a schematic of a WPAN network of wireless nodes and coordinators;

FIG. 2 shows a schematic of a wireless coordinator device of the present invention;

FIG. 3A shows a schematic of a WPAN network with a coordinator for managing wireless nodes associated with the network;

FIG. 3B shows a similar network to FIG. 3A, in which a wireless node of the PAN network is used as a range extender for communication with a distant coordinator;

FIG. 4 shows a similar network to FIG. 3A, in which the coordinator also acts as a gateway and portal to other networks;

FIG. 5 shows a schematic of a connected wireless node with memory for storing keys and a processor for executing encryption algorithms;

FIG. 6 shows a schematic of a WPAN of the present invention with tree topology;

FIG. 7A illustrates a wireless node identification key of the invention, including unique identifier;

FIG. 7B illustrates a wireless node identification key of FIG. 7A with additional device type identifier;

FIG. 7C illustrates a wireless node identification key of FIG. 7A with embedded bits to identify device type;

FIG. 8 shows a block diagram of the commissioning process of the invention;

FIG. 9 illustrates the steps, including commission key entry, in a first example of wireless node commissioning according to the present invention;

FIG. 10 illustrates the steps, including commission key entry, in a second example of wireless node commissioning according to the present invention;

FIG. 11 illustrates the steps, including commission key entry, in a third example of wireless node commissioning according to the present invention; and,

FIG. 12 illustrates the steps, including commission key entry, in an example of multiple wireless node commissioning according to the present invention.

### DETAILED DESCRIPTION

A Wireless Personal Area Network (WPAN) network according to the invention comprises at least a smart connected wireless coordinator device and a smart connected wireless node. The smart connected wireless coordinator device is adapted to allow new wireless nodes to associate as part of a private WPAN without compromising the network key. The smart connected wireless node is adapted to allow secure association and operation as part of a private WPAN without entering into a commission mode that renders the device vulnerable to un-authorised security or safety threats or un-authorised joining to neighbouring or overlapping wireless networks.

Although broadly applicable, the WPAN network of the present invention is particularly tailored and optimised for smart wireless lighting and for building control and management applications. The smart wireless nodes may include lighting nodes, lighting and building control nodes, building sensor nodes, chemical sensor nodes, presence and gesture control nodes, environmental sensor nodes and actuator nodes. The wireless lighting nodes may form part of a larger lighting and building control and management system. The smart wireless lighting nodes may comprise of retro-fit or replacement lamps or lighting fixtures or dedicated lighting products such as downlighters, tracklights, spotlights, recessed and suspended as well as office lighting.

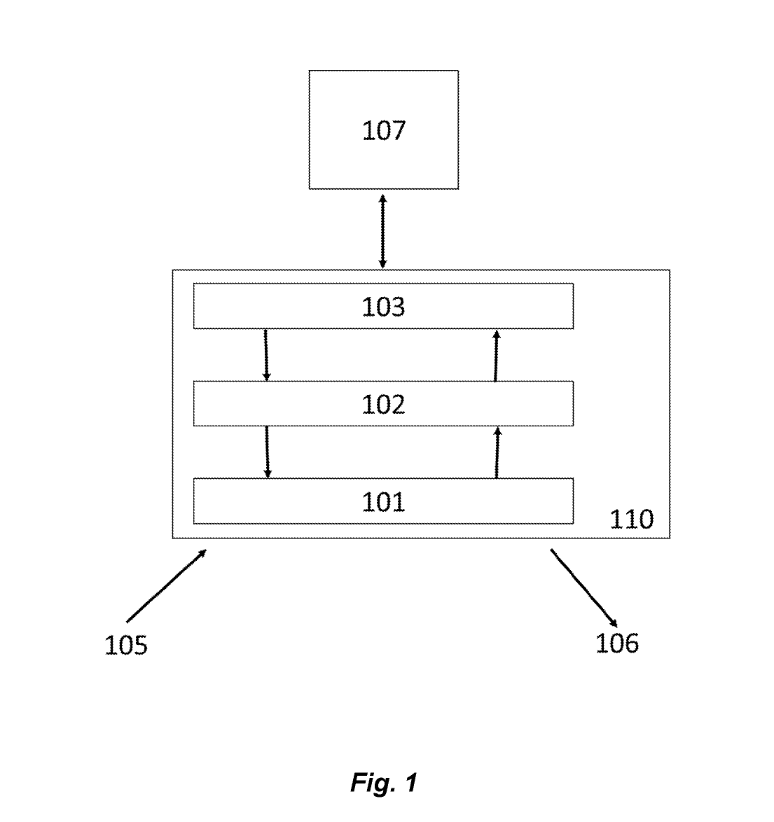

With reference to FIG. 1, the wireless nodes and coordinators within a WPAN will now be further described. Each device comprises a communication interface for receiving, 105, and transmitting data, 106, over a wireless medium. This may be but not limited to radio frequency and optical frequency and most preferably residing on a standard interconnection model, 110. The interconnection model enables two wireless nodes to communicate with each other regardless of device type and design. The interconnection model comprises of multiple layers of firmware within each wireless node. Layers communicate with each other via an application programming interface (API) allowing standardised sets of functions to accomplish specific tasks or to communicate with other layers or hardware.

The physical layer, 101, is preferably IEEE 802.11 or IEEE 802.15.4, but is not limited to such. The network layer, 102, may include, but is not limited to, Zigbee™, 6LoWPAN, Jennet-IP, Zwave™, Bluetooth™, and wireless HART. Sitting above the network layer is the application layer, 103. In some embodiments of the invention the application layer is a smart lighting and building control and monitoring application layer. However, it is important to note that the method of improved commissioning of wireless nodes is not limited to a specific application layer stack. Following commissioning, the application layer, 103, will resolve data packets and transport them in a transparent fashion to the intended lighting, monitoring or control devices, 107. The smart wireless lighting device, 107, may be integrated with the wireless node or coordinator, or remotely connected.

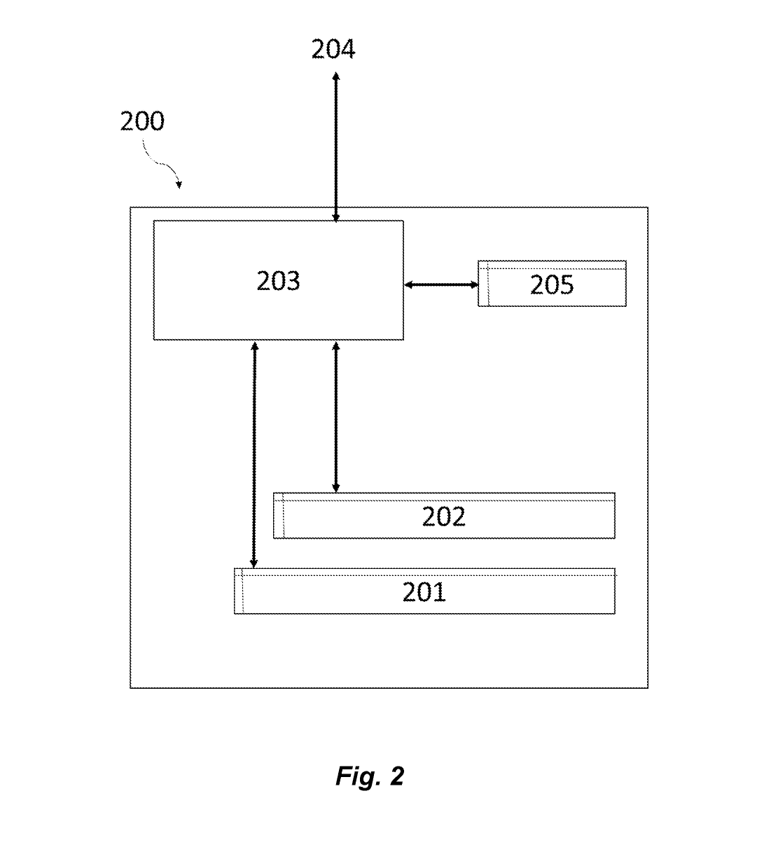

As show in FIG. 2, the wireless coordinator device, 200, includes information regarding the WPAN. This will include network identification, 201, and network security keys, 202. The network identification may be automatically generated by scanning all the neighbouring wireless networks and selecting a network identification that is not being utilised. The network identification may also be pre-defined by the user or factory set. The automatic generation of a network identification is a preferred method in order to eliminate conflicts with co-existing and collocated networks.

The wireless coordinator device is adapted to enable association of wireless nodes without compromising the security of the network key. The coordinator device will contain internal and or external memory to store the network key and buffer storage, 205, for information transmitted to and received from, 204, wireless nodes attempting to join, re-join or communicate with the network. The information may include, but is not limited to, the identification key, the commission key and encryption key. These keys are associated to the joining and joined wireless node but may be permanently or temporarily stored on the coordinator.

The coordinator will further include a processor, 203, having an encryption algorithm. The encryption key will be internally generated by the coordinator based on pre-defined algorithms.

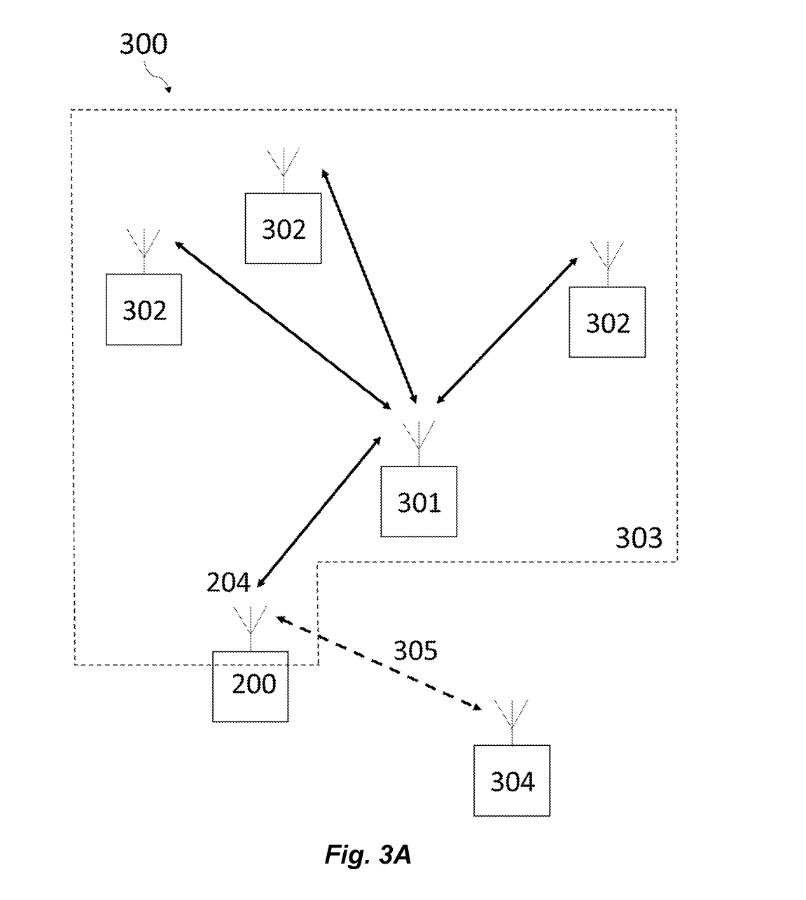

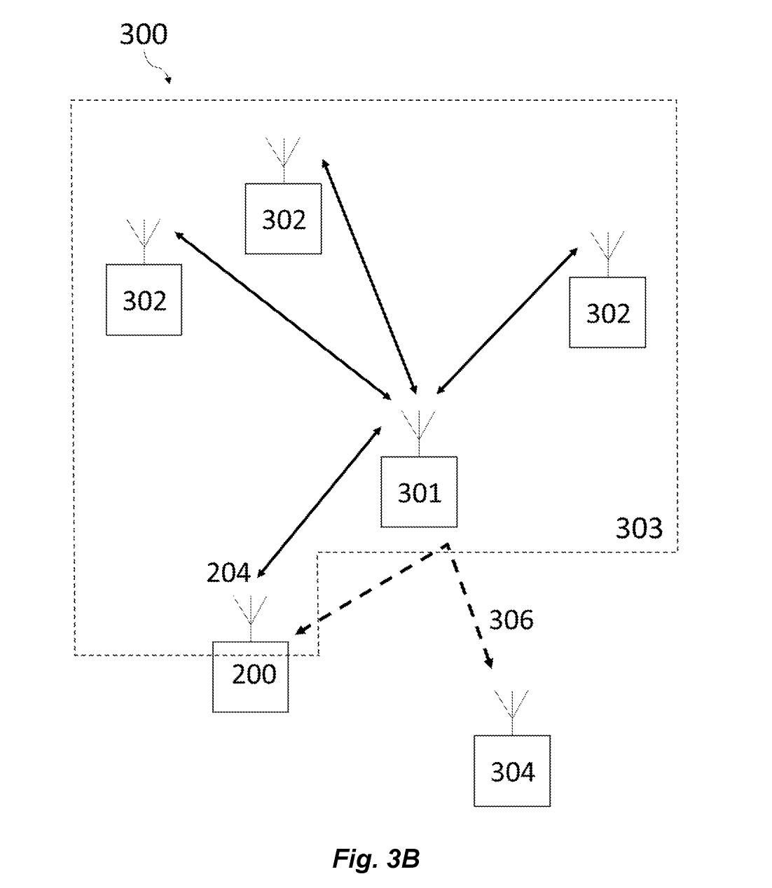

A WPAN network, 303, as shown in FIG. 3A, will have at least one coordinator, 200, that will manage the association, addition, removal and re-join of new wireless nodes, 301 and 302. The coordinator may communicate insecurely, 305, with other devices, 304, outside the private network, 303, but also on the same wireless channel. This enables new wireless nodes, 304, to associate with the private network without compromising the security of the network.

In some embodiments the associating wireless node may employ at least one additional wireless node, 301, that is part of the PAN network as a range extender in order to enable communication, 306, with a distant coordinator, 200. This is depicted in FIG. 3B. It is important to note that, in the present example, node 304 will be communicating unsecured to 200 via 301, but is still not part of WPAN network 303 as the node 304 does not hold the network key. Node 304 employs 301 as a node to re-broadcast messages.

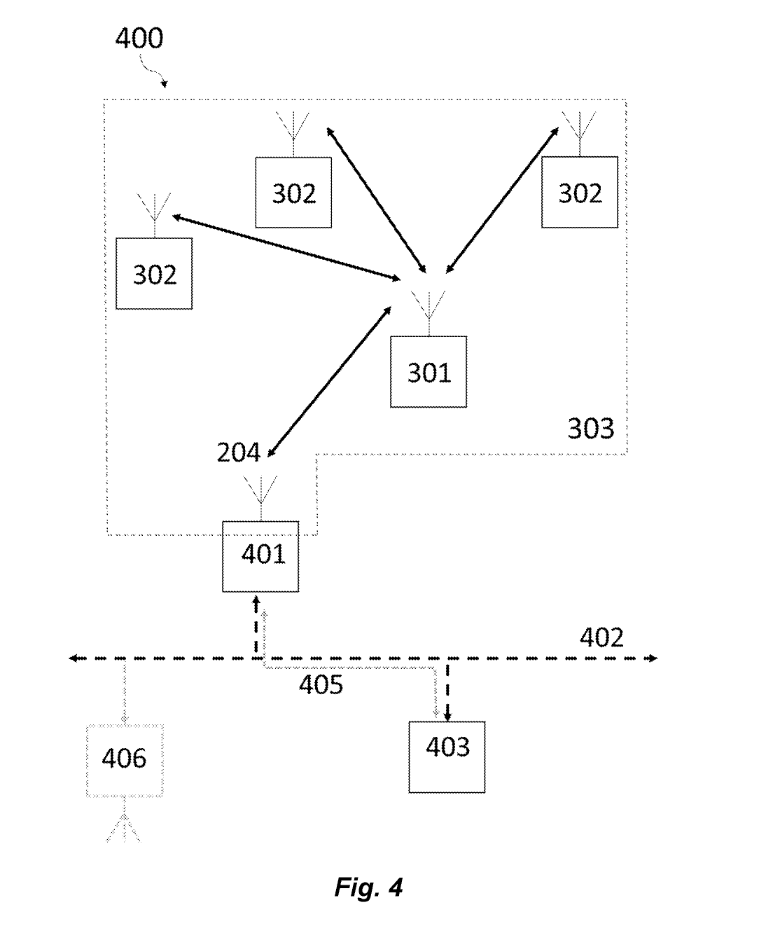

In some embodiments the coordinator may further act as a gateway and portal, 401, to a wired network such as a Local Area Network (LAN), Wide Area Network (WAN) or other wireless networks such as wireless LAN (WLAN) or wireless WAN (WWAN), as illustrated in FIG. 4. These are indicated by the by dashed line 402. The gateway, 401, will receive, transmit and process communication data from any of the networks residing on 402 and reformat and re-broadcast the information to the wireless nodes on the WPAN network, 303. Once the data has been transmitted securely into the network 303, the gateway will act as a coordinator for the WPAN. The gateway may hold identification mapping tables to map the internal WPAN address of a specific wireless node to external addresses, such as static or dynamic IP addresses on the LAN or WAN networks.

The gateway may further have the ability to communicate with the user using a direct wired or wireless human machine interface (HMI). Alternatively, the communication can be an indirect link via an area network, 402, leading to a network host device such as 403. The IP based host device may, for example, be a handheld device, smartphone or tablet able to transmit commands, 405, across 402 to the gateway 401. The gateway 401 and host device, 403, may utilise one of multiple internet protocol application layer methods to communicate across the 402 network. These include, but are not limited to, DHCP, DHCPv6, DNS, FTP, HTTP, IMAP, POP, SMTP, SOCKS, SSH, MATT, Telnet, and others.

Multiple WPAN networks 303 and gateways, 401 and 406 for example, may co-exist on the same local or wide area network, 402. Each gateway 401, 406 will have a unique IP address and hence enable one or more host devices to communicate to any of the gateways connected on the same local/wide area network.

In the invention, user communication with the coordinator is required for the direct entry of the commissioning key for the association of wireless nodes, as well as possible direct interaction with wireless nodes.

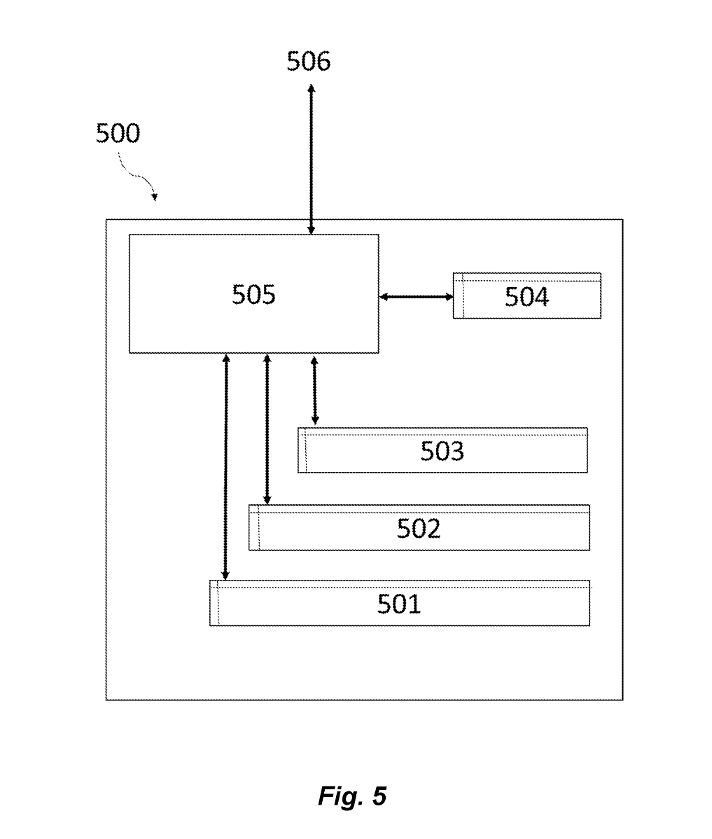

The smart connected wireless node, 500, is adapted to have internal memory, as shown in FIG. 5. The internal memory will at least store a commission key, 502, an identification key, 501, and a network key, 503. The identification key, 501, is unique to the wireless node and no other device on the same WPAN may have the same identification key. The key can be, but not limited to, a username or Media Access Control (MAC) address. In some embodiments this identification key is freely broadcast over the wireless network (over-the-air) by the device with no encryption and allows the device to be uniquely discovered and identified. The same username may be repeated by other wireless nodes in other WPAN networks.

Once the identification key is broadcast, it may be combined with a device type or device descriptor. This will enable the coordinator to identify the type of joining node 500 and ensure the correct set-up parameters or commissioning method is employed. For example, multiple devices may be commissioned at the same time, and so in order to differentiate an occupancy sensor device and a lighting node at the point of out-of-band entry of the commission key, the user may be notified that the node currently being commissioning is of a specific device type.

The wireless node will further include a processor, 505, having an encryption algorithm. The encryption key generation will be matched to that residing on the coordinator. The encryption key is generated by an algorithm that is pre-defined by a mathematical combination or hash function of the commission key and the identification key. The mathematical combination may be randomly selected from a group of possible combinations. The wireless node may contain additional internal memory, 504, to store data required during communication with the application specific hardware, 506.

Following association, the wireless node may act as a router or as an end node. In the former configuration the wireless node acts to receive and re-broadcast data across the WPAN network, thereby assisting in expanding the coverage or bandwith of the network. In the latter configuration the wireless node acts as a receiver and transmitter of data only to itself.

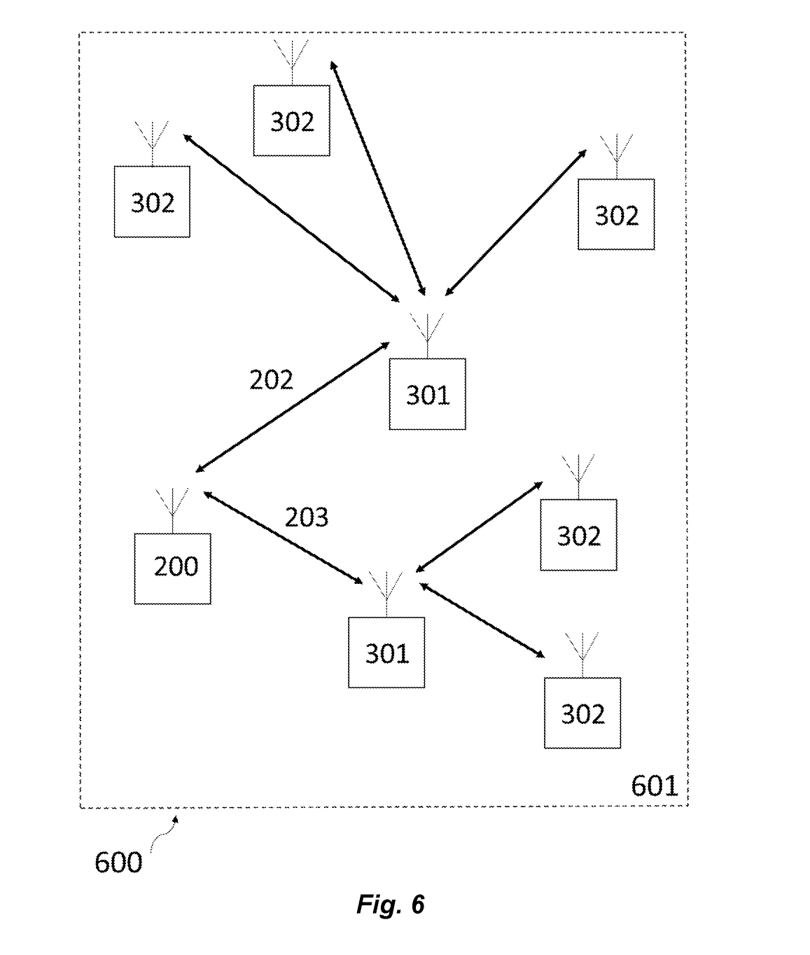

It is an object of the invention that multiple wireless nodes may associate and join the WPAN network. The multiple wireless nodes may form a network topology suitable for the physical and network layer selected for the WPAN network. This may include, but is not limited to, a bus, ring, star, tree or mesh network. Variations in network topology do not impact any aspect of the invention. Therefore, for simplicity, a tree network topology, 601, will be selected for subsequent examples of the invention, as shown in FIG. 6.

In the arrangement shown in FIG. 6 a wireless PAN network, 600, having a single coordinator, 200, communicates with two router nodes, 301. The router nodes subsequently communicate with end nodes 302. The end node will classify the router they are associated to as the parent device and all information from and to an end node will be propagated up and down the tree structure.

A WPAN according to the invention relies on securely sharing a network key with all associated wireless nodes and coordinators to ensure all nodes operate as part of the same secure WPAN network. For the avoidance of doubt, the term “shared” details the process whereby a key or data packet is transmitted between two or more devices wirelessly over the same communication channel.

It is an object of the invention that the wireless node may be commissioned and associated to the WPAN network without physical contact to the node. This is desirable when multiple nodes are being associated simultaneously and accessibility to the nodes is difficult.

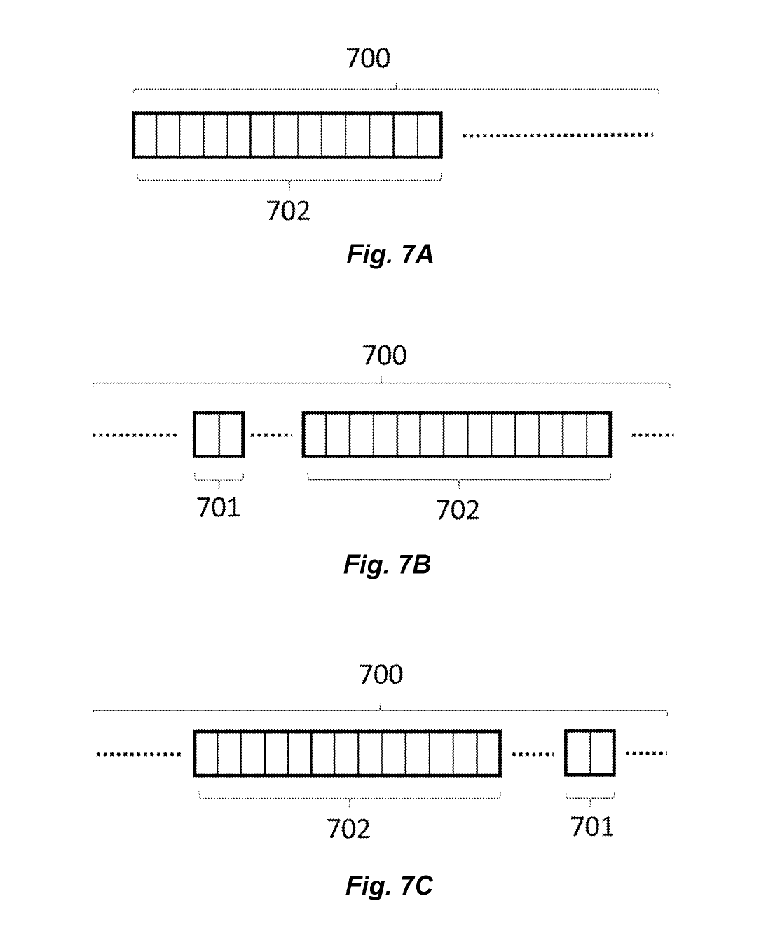

In a further feature of the invention, the wireless node identification key, 700, is a unique identifier for all nodes and coordinators on a wireless network. As shown in FIGS. 7A-C, the unique identifier may be a form of username for the wireless node. This unique identifier, 700, may include, 702, any of a MAC address, an organisationally unique identifier, and a globally unique identifier, as shown in FIG. 7A.

The identifier, 700, may additionally include a device type identifier, 701. This may comprise of a username header defining the device type, as shown in FIG. 7B. Alternatively, it may comprise a single or multiple bits embedded within the packet to identify different device types, as shown in FIG. 7C. This is desirable to enable the coordinator to differentiate the device type and to configure the wireless node correctly prior to the node associating to the WPAN. This is also advantageous in physical identification of wireless nodes during commissioning of the wireless node. The coordinator will provide information to the human user on device type prior to the node association allowing improved identification or user experience and commissioning simplicity.

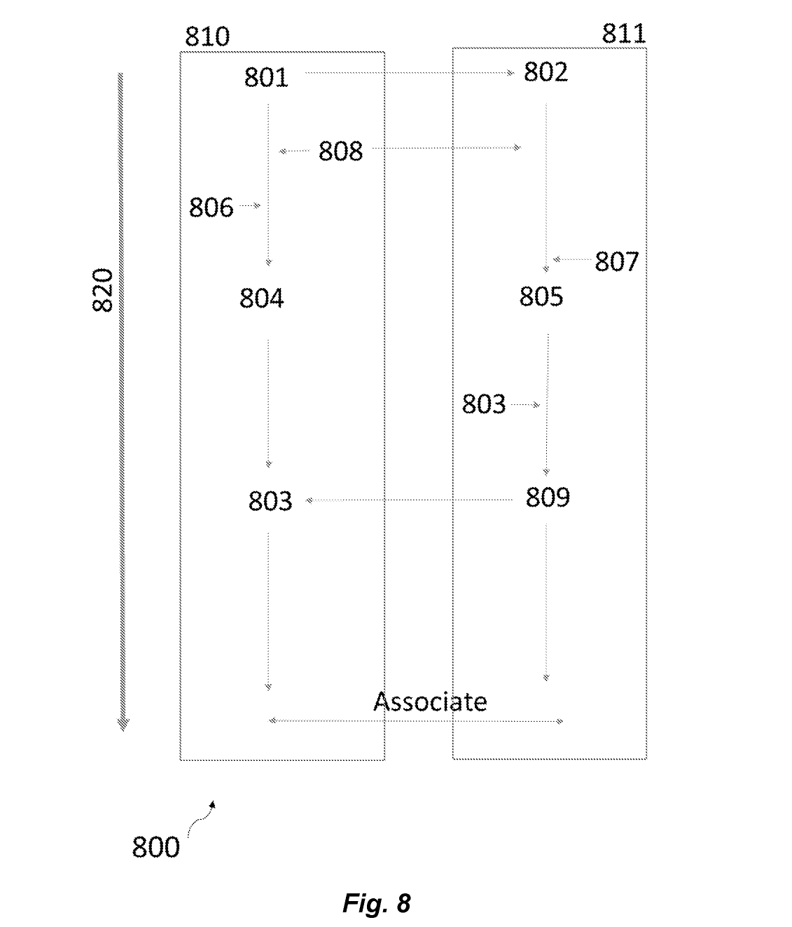

The steps taken by a wireless node to associate a wireless PAN network will now be described in detail with reference to FIG. 8, which shows a block diagram highlighting the main elements in the commissioning process of the invention. In particular, the block diagram highlights a sequence of events that will occur over a time path 820.

During an association process a new wireless node, 810, will send an association request, 801, to all neighbouring WPAN networks. The coordinator, 811, of the desired WPAN network will receive the request and store the identification key for the wireless node and initiate the association process, 802. The wireless node, 810, will hold in the internal memory the commission key, 806, and the unique identification key, 808, as well as a constructed encryption key, 804.

In order to securely broadcast the network key, 803, to the wireless node, an encryption key, 804, will be constructed by the coordinator and employed to encrypt the network key. The network key, 803, is locally stored on the coordinator, 811. The encryption key, 803, is private and unique to the wireless node, 810. However, the encryption key, 805, is also re-constructed by the coordinator 811 during the first association process. The encryption key, 805, is constructed from the commission key, 807, and the identification key, 808.

At this point the coordinator already holds the identification key, 808, but not the commission key, 807. To ensure security, the commission key, 807, is passed out-of-band, i.e. not transmitted using wireless, to the coordinator 811. This can be in the form of physical printing of the key on the wireless device 810. The commission key is entered into a HMI interface or gateway portal to the coordinator and not held by the coordinator prior to association process.

At this point the coordinator is able to remotely re-construct the encryption key, 805. It is important to note that the commission keys, 806 and 807, are identical and at this point in the association the encryption key 804 generated by node 810 and the encryption key 805 generated by the coordinator 811 are also identical.

The coordinator will transmit the encrypted network key, 809, at least partially, over the unsecured wireless network to the wireless node, 810. The wireless node will decrypt the encrypted network key, 809, using the matched algorithm and the encryption key, and will retain in the internal memory the network key, 803, once decrypted. This will enable the wireless node to associate with the private network.

Both the wireless coordinator and node contain a processor having matched encryption algorithms. The encryption key for the algorithm is pre-defined by a mathematical combination or hash function of the commission key and the identification key. The mathematical combination or hash function may also be randomly selected from a group of possible combinations that are pre-defined and stored in the memory of the wireless node and the coordinator.

If the randomly selected encryption keys do not match, then the random combination is re-constructed at the coordinator and re-tried. If all the possible combinations are tried and the wireless node association was not successful then the user is notified that the commission key is incorrect or an unauthorised device attempted to join the private WPAN.

The encryption applied to the network key may be, but is not limited to, an Advanced Encryption Standard (AES-128) or ANUBIS-128 or similar substitution-permutation network algorithms. The encryption key may further be concatenated with the commission key and processed with a pre-defined cryptographic hash function. The mathematical combination may comprise, but is not limited to, a simple addition, subtraction, multiplication or packing of the commission key into the identification key.

When using a group of possible combinations of encryption keys in the wireless node and coordinator, it may be preferable for these to comprise a list of 2, 3 or 4 encryption keys. The encryption keys are randomly selected using a random number generator. It is important to note that the combination of encryption key formation/generation algorithms needs to be matched between the wireless nodes and the coordinator. This is pre-defined during manufacture and stored, 203, 205 and 504, 505, in the coordinator and wireless node, respectively.

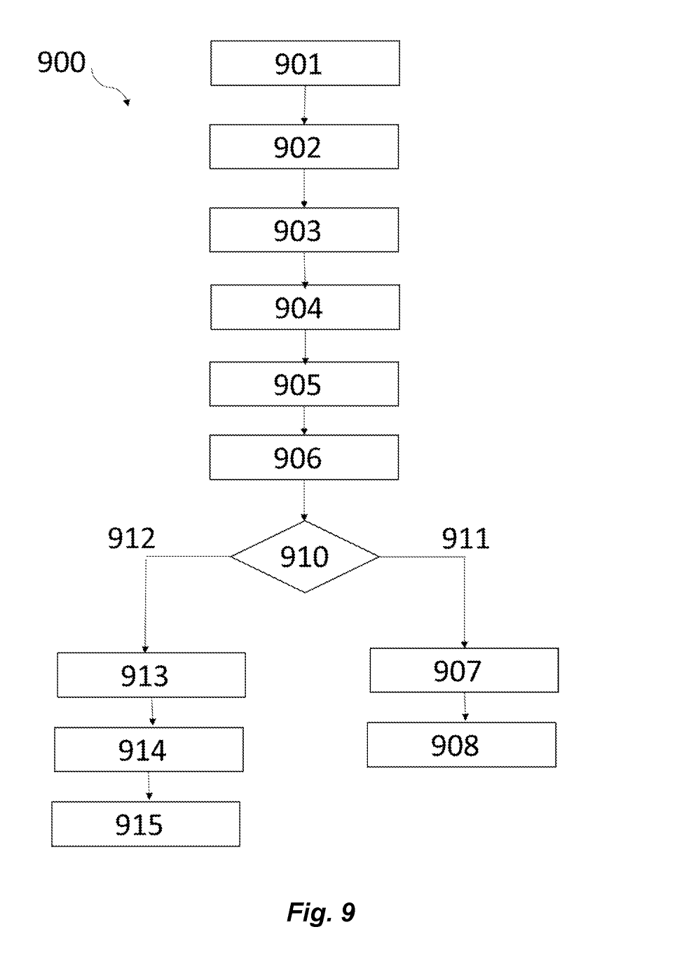

FIG. 9 shows a first example of the simple steps that a user may take to associate a wireless smart lamp node with a private network, 900, using the invention. In this example the private network is assumed to be pre-defined and containing a coordinator having a network key. The un-associated wireless node will send a beacon message requesting to join the secured private network, 901. The coordinator will receive this message notifying that a wireless node is requesting to join the network, 902. This may be received directly or indirectly through a router node.

In this first example, the coordinator further comprises gateway functionality. The gateway is connected to a LAN and has an IP address. In a preferred form of user communication with the gateway, a host device, such as a smartphone or tablet, will connect to a web-server hosted on the gateway. The web-server will post and get information to and from all the nodes residing on the WPAN and display this in a web-based application accessible via a webpage. At this point the host device will be notified on the web application that a new device has been found and is requesting to join the WPAN, 903. The identification key of the device will be displayed on the web application and, in the case of a smart lamp, the lamp itself will provide visual notification, such as flashing. The user will be requested for a commission key for the joining device, 904. The commission key is physically entered by the user via the web application and is posted to the gateway, 905. In this example, the commission key is pre-defined during production and the physical alphanumeric, decimal, hexadecimal or binary key is affixed to the wireless lamp or its associated packaging.

The gateway/coordinator will employ the commission and identification key to encrypt the network key. This is transported to the wireless node, 906, and a decision point, 910, is entered. If the encryption key is matching, 911, then the wireless node will successfully be able to associate to the WPAN and the gateway will add the device to the list of joined devices, 907. The gateway will update the web application with the wireless node being successfully joined, 908.

In the case that the commission key is incorrect, 912, the network key will not be encrypted correctly by the wireless node and the coordinator will not allow the wireless node to join the WPAN, 913. In this case, the gateway will update the web application and notify the user that the wireless node has failed to join the network, 914. The node will be returned to the group of discoverable new devices requesting to join and no further actions are progressed, 915. The user may wish to repeat the commission process by typing in another commission key, at step 904.

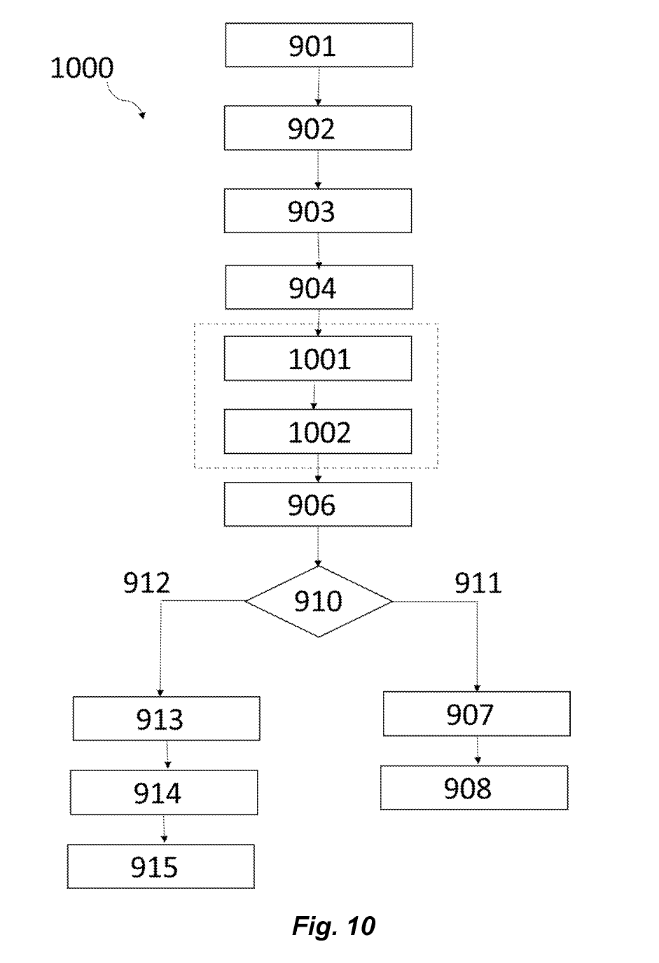

FIG. 10 shows a second example of the steps that a user may take for entering the commission key for wireless lighting nodes in an improved method of the invention. During the visual notification procedure of the wireless lighting device, 903, the wireless lamp will further emit information using modulations in the light output or light spectral density, 1001. This may take the form of pulses or modulations of all or part of the emitted spectrum of the light generated by the wireless lighting device. Pulses may comprise of pulse width modulation (PWM), pulse density modulation (PDM), pulse amplitude modulation (PAM) or a combination of any or all of these.

The modulated light will emit the commission key using an out of wireless band method, and the commission key is received and de-coded by a light detector device designed to receive the modulated light, 1002. The commission key may be displayed on the light detector device and physically entered by the user via the web application and posted to the gateway, or preferably, the light detector device is physically connected or part of the host device enabling direct posting of the commission key into the wireless lighting API or web application.

The light detector may be part of the Human machine interface (HMI) or host device. The light detector device may comprise a camera, light sensor, IR transceiver, or photodiode. Alternatively, the light detection means may comprise a software application on a host device having a means of detecting light modulations, such as a camera, IR transceiver or ambient light sensor.

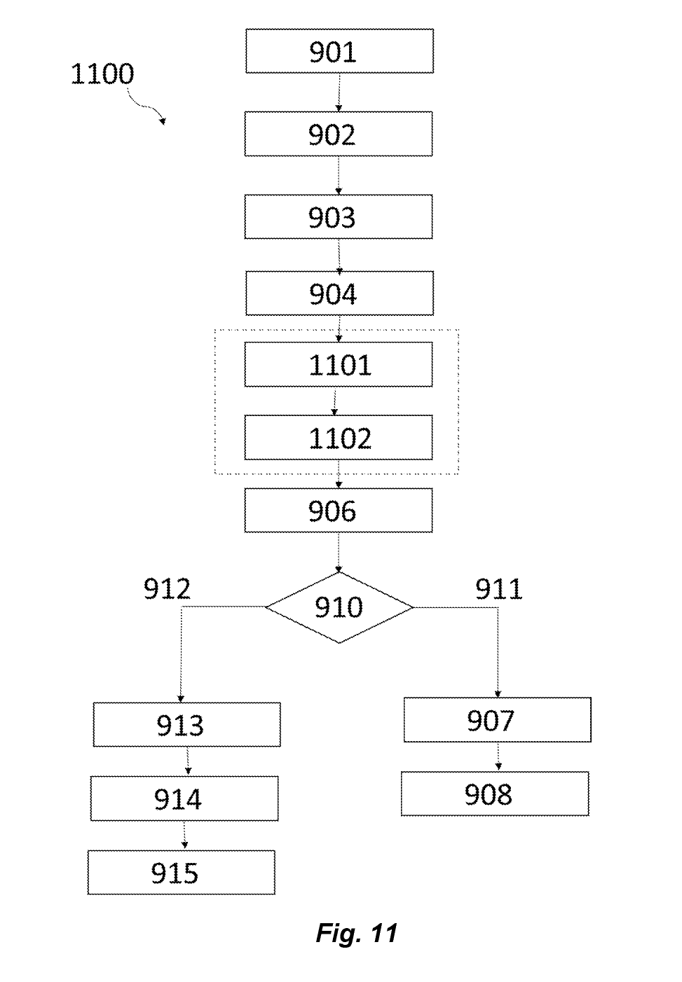

FIG. 11 shows a third example of the steps that a user may take for entering the commission key for wireless lighting nodes in another improved method of the invention. The wireless node will further include an additional active or passive communication means to transmit the commission key out of the WPAN band, 1101 as a secondary wireless signal. This may be in the form of communication using a secondary, active or passive, wireless component embedded in the wireless node. The secondary wireless device is dedicated for the transmission of the commission key.

The secondary wireless component may transmit the commission key using a suitable protocol, which may include one of the following: Bluetooth™, near field communication (NFC), and radio-frequency identification (RFID). The secondary wireless component may be powered by the wireless node or have a separate power storage device. Alternatively, the secondary wireless component may be a passive target component initiated by an electromagnetic field generated by the initiator device. The initiator may be part of the Human machine interface (HMI) or host device. Alternatively, the initiator may comprise a software application on a host device having a means of receiving and processing the secondary wireless signal.

The commission key is received and de-coded by the initiator device designed to receive the secondary wireless message, 1102. The commission key may be displayed on the initiator device and physically entered by the user via the web application and posted to the gateway, or preferably the initiator device is physically connected or part of the host device enabling direct posting of the commission key into the wireless lighting API or web application, thus enabling automatic association of the wireless node.

In yet another example of the invention, the commission key is encoded in a graphic or image affixed on the wireless node, on the packaging of the device, in the vicinity of the wireless node or related to the physical location of the wireless node using other diagrammatic or descriptive forms. The image may comprise a bar code, QR code or a graphical image comprising unique pre-defined identifiable features.

In this example, the commission key is acquired using an image processing device such as a barcode, QR code reader of camera device. The image processing device may be part of the Human machine interface (HMI) or host device such as a camera on a smartphone or tablet device. Alternatively, the image processing device may comprise a software application on a host device having a means of receiving and processing the graphic or image.

The commission key is received and de-coded by the image processing device and is directly posted from the host device onto the gateway via the wireless lighting API or web application, thus enabling automatic association of the wireless node. The commission key may comprise at least 1 alphanumeric character. Preferably, the character comprises a binary, hexadecimal or decimal number. In a preferred embodiment the commission key comprises 2, 3 or 4 hexadecimal numbers.

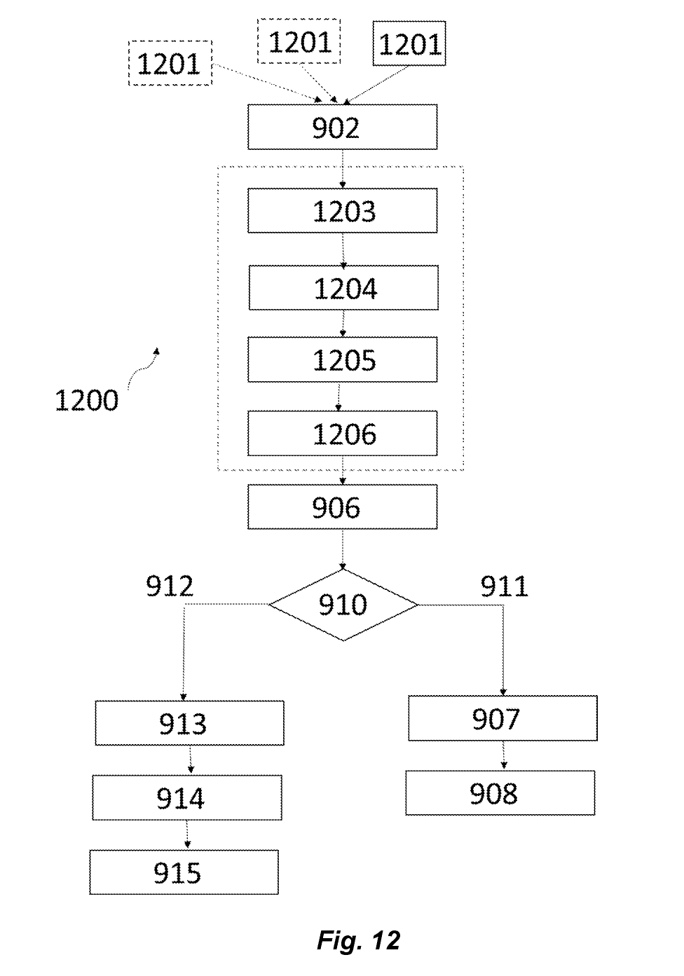

In a further preferred embodiment of this example, the identification key and the commission key are stored and transmitted together in the out-of-band communication, as described in any of the examples above. This provides a further improvement in the association process during commissioning of multiple devices, as illustrated in FIG. 12.

During the association process multiple wireless nodes will transmit their beacon messages containing the identification key to the coordinator device, as shown in 1210. In step 1203 the user will be notified with multiple devices trying to associate to the WPAN network. A list will display the multiple node information derived from the identification keys. In step 1204 the user will be notified to enter the wireless node details to be associated. In order to identify the joining wireless node, the identification key is simultaneously transmitted out of band along with the commission key, as shown in step 1205. This may be communicated in any of the forms explained in any of the examples detailed above.

In one example, a QR code is employed to encode the identification key as well as the commission key. Alternatively, during visual notification, the wireless lamp will emit modulated light encoding the identification and commission key. A host device having a secondary camera and software application will acquire an image of the QR code or modulated light of the desired wireless node. This is decoded and the host device will generate the identification key and commission key simultaneously, 1206. The host device will communicate with the gateway via LAN or WAN and identify the desired joining device by matching of the identification key to that on the gateway list of nodes requesting association. The host device will follow by posting the commission key to the gateway. The gateway will then encrypt the network key with the correct encryption key for the desired wireless node as shown in 906. The association process will continue as before allowing successful association of any wireless node with minimal user input.

It is important to note that the identification and commission key in any of the above mentioned examples can be stored on an rfid component, passive nfc, barcode, QR code or broadcast out of band using coded light or secondary wireless signal such as Bluetooth^{lM} or ANT+ or active nfc.

1. A wireless node device adapted to associate with a private wireless network over a wireless medium, the wireless node device comprising:
memory storing a commission key and an identification key, the commission key for use in commissioning the wireless node device and the identification key comprising a unique identifier for uniquely identifying the wireless node device on the private wireless network;
means for notifying the commission key out-of-band;
means for notifying the identification key;
means for receiving an encrypted network key for the private wireless network over the wireless medium;
a processor adapted to execute:
(i) a predefined encryption algorithm to generate an encryption key by a mathematical combination of the commission key and the identification key; and,
(ii) a predefined decryption algorithm to decrypt the received encrypted network key using the generated encryption key; and,
a physical data transport layer adapted to utilise the decrypted network key to associate the wireless node device with the private wireless network.

2. A wireless node device according to claim 1, wherein the means for notifying the identification key comprises means for broadcasting the identification key in-band over the wireless medium.

3. A wireless node device according to claim 2, wherein the means for broadcasting and the means for receiving are comprised in a communications interface of the wireless node device.

4. A wireless node device according to claim 1, wherein the means for notifying the identification key is adapted to do so out-of-band.

5. A wireless node device according to claim 1, wherein the wireless node device comprises a light emitting element.

6. A wireless node device according to claim 1, wherein the means for notifying the commission key out-of-band comprises a printed key affixed to the wireless device.

7. A wireless node device according to claim 1, wherein the means for notifying the commission key out-of-band comprises a machine readable 1D or 2D printed bar code.

8. A wireless node device according to claim 1, wherein the means for notifying the commission key out-of-band comprises an out-of-band wireless transmitter.

9. A wireless node device according to claim 5, wherein the means for notifying the commission key out-of-band comprises a pulse modulated light signal generated by the light emitting element.

10. A wireless node device according to claim 5, wherein the means for notifying the commission key out-of-band comprises a colour modulated light signal generated by the light emitting element.

11. A wireless node device according to claim 1, wherein the unique identifier comprises one of a MAC address, an organizationally unique identifier and a globally unique identifier.

12. A wireless node device according claim 1, wherein the identification key further comprises a device type identifier for identifying the device type of the wireless node device.

13. A wireless node device according to claim 12, wherein the device type identifier comprises a username header for the identification key.

14. A wireless node device according to claim 12, wherein the device type identifier comprises on or more bits embedded in the identification key.

15. A wireless node device according to claim 1, wherein the wireless node device is adapted to employ another wireless node device associated with the private wireless network for communicating with a wireless coordinator device associated with the private wireless network.

16. A wireless coordinator device adapted to coordinate association of a wireless node device to a private wireless network over a wireless medium, the wireless coordinator device comprising:
memory storing a network key;
a physical data transport layer adapted to utilise the network key to associate the wireless coordinator device with the private wireless network;
means for receiving a commission key out-of-band, the commission key for use in commissioning the wireless node device;
means for receiving an identification key for the wireless node device, the identification key comprising a unique identifier for uniquely identifying the wireless node device on the private wireless network;
a processor adapted to execute:
(i) a predefined encryption algorithm to generate an encryption key by a mathematical combination of the received commission key and the received identification key; and,
(ii) a predefined encryption algorithm to encrypt the network key using the generated encryption key;
means for transmitting the encrypted network key to the wireless node device over the wireless medium.

17. A wireless coordinator device according to claim 16, further comprising a network identification for the private wireless network.

18. A wireless coordinator device according to claim 17, wherein the network identification is predefined and stored in the memory.

19. A wireless coordinator device according to claim 17, wherein the network identification is automatically generated by scanning neighbouring wireless networks to avoid assigning a conflicting network identification.

20. A wireless coordinator device according to claim 16, wherein the means for receiving the identification key for the wireless node device and the means for transmitting the encrypted network key to the wireless node device over the wireless medium are comprised in a communications interface of the wireless coordinator device.

21. A wireless coordinator device according to claim 16, wherein the means for receiving the identification key for the wireless node device is adapted to do so out-of-band.

22. A wireless coordinator device according to claim 16, wherein the means for receiving the commission key out-of-band comprises means for physically entering the commission key to the wireless coordinator device.

23. A wireless coordinator device according to claim 16, wherein the means for receiving the commission key out-of-band comprises bar code reading means to read a 1D or 2D printed bar code representing the commission key.

24. A wireless coordinator device according to claim 16, wherein the means for receiving the commission key out-of-band comprises means to receive a wireless out-of-band signal.

25. A wireless coordinator device according to claim 16, wherein the means for receiving the commission key out-of-band comprises means to detect a pulse modulated light signal representing the commission key.

26. A wireless coordinator device according to claim 16, wherein the means for receiving the commission key out-of-band comprises means to detect a colour modulated light signal representing the commission key.

27. A wireless coordinator device according to claim 16, configured to act as a gateway to a further network and hosting a web server for communicating with a host device via the further network.

28. A wireless coordinator device according to claim 27, wherein the commission key is received out-of-band from the host device via the further network.

29. (canceled)

30. A private wireless network according to claim 29, wherein at least one associated wireless node device comprises a light emitting element and at least one wireless node device comprises an environmental sensor element.

31. (canceled)

32. (canceled)

33. A method of commissioning a wireless node device on a private wireless network, the method comprising the steps of, at the wireless node device:
notifying a commission key out-of-band, the commission key for use in commissioning the wireless node device;
notifying an identification key for the wireless node device, the identification key comprising a unique identifier for uniquely identifying the wireless node device on the private wireless network;
receiving an encrypted network key for the private wireless network over a wireless medium;
generating an encryption key by a mathematical combination of the commission key and the identification key; and,
decrypting the received encrypted network key using the generated encryption key; and, utilising the decrypted network key to associate the wireless node device with the private wireless network.

34. A method according to claim 32, the method further comprising the steps of, at a wireless coordinator device:
receiving the commission key out-of-band;
receiving the identification key for the wireless node device;
generating an encryption key by a mathematical combination of the received commission key and the received identification key;
encrypting a network key for the private wireless network using the generated encryption key; and,
transmitting the encrypted network key over the wireless medium.

35. A method of commissioning a wireless node device on a private wireless network, the method comprising the steps of, at a wireless coordinator device:
receiving a commission key out-of-band;
receiving an identification key for the wireless node device, the identification key comprising a unique identifier for uniquely identifying the wireless node device on the private wireless network;
generating an encryption key by a mathematical combination of the received commission key and the received identification key;
encrypting a network key for the private wireless network using the generated encryption key; and,
transmitting the encrypted network key to the wireless node device over the wireless medium.

36. A method according to claim 34, wherein the commission key is received out-of-band from a host device in communication with the wireless coordinator device over a different network than the private wireless network.

37. A method according to claim 35, wherein the commission key is received out-of-band from a host device in communication with the wireless coordinator device over a different network than the private wireless network.
